(19) United States
(12) Patent Application Publication
(10) Pub. No.: US 2011/0274788 A1
(43) Pub. Date: Nov. 10, 2011

(54) TEA EXTRACT AND METHOD FOR PRODUCING THE SAME

(75) Inventors: Kenji Saito, Hiratsuka-shi (JP); Tadahiro Hiramoto, Hiratsuka-shi (JP)

(73) Assignee: TAKASAGO INTERNATIONAL CORPORATION, Ohta-ku, Tokyo (JP)

(21) Appl. No.: 13/145,435

(22) PCT Filed: Jan. 28, 2010
(86) PCT No.: PCT/JP2010/051546

§ 371 Date: Jul. 20, 2011

(30) Foreign Application Priority Data
Jan. 29, 2009 (JP) 2009-018287

(51) Int. Cl. A23F 3/16

(52) U.S. Cl. 426/52; 426/597; 426/655

(57) ABSTRACT

To provide a tea extract more excellent in flavor, with formation of deposits inhibited, the present invention provides a method for producing a tea extract, comprising the step of treating a raw material tea by using raw tea leaves and an enzyme preparation having a polygalacturonase activity.

### TECHNICAL FIELD

The present invention relates to a tea extract including no deposits and excelling in flavor.

### BACKGROUND ART

Teas are roughly classified into three types depending on the degree of fermentation in their production process, namely, non-fermented teas represented by green tea; semi-fermented teas represented by oolong tea; and fully fermented teas represented by black tea, and are widely drunk all over the world. Recently, tea beverages obtained by filling an extract from tea into a container have been developed.

In particular, as consumers become increasingly sensitive to food safety, there is a demand for a tea extract usable as a raw material for tea beverages which includes neither deposits nor suspended matters, and which thereby visually cause no concern over safety.

Moreover, as consumers are becoming increasingly particular about the taste of beverages and foods in recent years, tea beverages with a rich flavor like a high quality tea are preferred.

The following method has been proposed as a method for providing, at a low cost, a tea extract usable as a raw material for tea beverages with a rich flavor like a high quality tea. In the method, after raw leaves and/or twigs of tea are picked, a raw tea leaf powder is obtained by performing a lyophilization treatment on the raw leaves and/or twigs of tea, followed by grinding. Then, a tea extract is prepared by treating a liquid extracted from tea, with the raw tea leaf powder added thereto (International Patent Application Publication No. WO/2005-039301).

By causing the raw tea leaves to act on the liquid extracted from tea, various enzymes of the raw tea leaves react with substrates in the liquid extracted from tea. As a result, this tea extract has an excellent taste and a strong flavor, and is also inexpensive. Accordingly, this tea extract is an excellent tea extract which solves the above problems. However, a drawback caused by making the tea extract higher in quality is that the reaction of the liquid extracted from tea using the raw tea leaves is accompanied by formation of causative substances causing deposition. For this reason, as time goes on, deposits are formed in the thus obtained extract stored for a long period of time, resulting in a problem that the commercial value of the product is significantly deteriorated. Hence, there is a demand for improvement.

Meanwhile, as methods of preventing deposits derived from polysaccharides of tea extract, methods using several enzymes in combination have been known such as: a method of treating a tea extract with four kinds of enzymes including cellulase, hemicellulase, pectinase, and protopectinase (Japanese Patent Application Publication No. 2003-210110); a method of treating a tea extract with an enzyme having a hemicellulase activity with ascorbic acid or a salt thereof added thereto (Japanese Patent Application Publication No. Hei 8-228684); and a method of treating a tea extract with a 6-mannanase or an enzyme preparation mainly containing a 6-mannanase (Japanese Patent Application Publication No. 2002-119209).

The causative substances causing deposits described in these techniques are polysaccharides originally contained in the liquids extracted from tea, and refer particularly to deposits of hemicelluloses. Such causative substances are different from those formed in the reaction using raw tea leaves. In addition, it has been considered that a deposition preventing effect on such deposits cannot be obtained only by causing a pectinase or a cellulase to act on the liquids extracted from tea.

### SUMMARY OF INVENTION

An object of the present invention is to provide a tea extract more excellent in flavor, with formation of deposits inhibited.

The present inventors have made an earnest study to solve a problem that deposits are formed in a tea extract which is inexpensive and excellent in taste and flavor. As a result, the present inventors have found that a treatment with an enzyme preparation having a polygalacturonase activity makes it possible to obtain a tea extract more excellent in flavor, with formation of deposits inhibited. This finding has led to the completion of the present invention.

Specifically, the present invention provides a method for producing a tea extract, comprising the step of treating a raw material tea by using raw tea leaves and an enzyme preparation having a polygalacturonase activity.

Moreover, the present invention provides a tea extract obtained by the production method.

Furthermore, the present invention provides a food or beverage comprising the tea extract.

According to the present invention, it is possible to inhibit the formation of deposits in a tea extract with a rich flavor like a high quality tea, and to provide a tea extract more excellent in flavor.

### DESCRIPTION OF EMBODIMENTS

The method for producing a tea extract of the present invention is characterized by the step of treating a raw material tea by using raw tea leaves and an enzyme preparation having a polygalacturonase activity.

Examples of the raw material tea used in the present invention include: green teas such as SENCHA, BANCHA, GYOKURO, TENCHA and KAMAIRICHA, the green teas being non-fermented teas and being produced from raw tea leaves obtained from the tea plant (scientific name: Camellia sinensis), which is an evergreen plant in the family Theaceae; and teas such as oolong tea, black tea, and black-colored tea (post-heating fermented tea), which are produced from the above-described raw tea leaves through a semi-fermentation process or fermentation process. The form during the treatment may be a slurry form where tea leaves and water are mixed; alternatively; an extracted liquid from which tea leaves are removed after extraction may be used. The temperature of the extraction is not particularly limited, as long as the temperature is industrially practical. The temperature may be 0 to 100° C., and preferably 20 to 80° C.

The raw tea leaves used in the present invention refer to raw leaves of the tea plant (scientific name: Camellia sinensis). Besides raw tea leaves as they are, a non-heated processed product, such as a frozen product of raw tea leaves, a ground frozen product of raw tea leaves, a lyophilized and then ground product of raw tea leaves, or a ground and then lyophilized product of raw tea leaves can be used as the raw tea leaves. The enzyme activity may be enhanced by physically damaging the leaves to induce expression of enzymes before a process for obtaining any of the above-descried products. Moreover, an extract liquid obtained by extracting enzyme components, with a solvent, from the above-described raw tea leaves or a processed product thereof may be used. It should be noted, however, that there is a limitation that a heat treatment which may impair the enzyme activity is not conducted in any of the preparation methods.

The amount of the raw tea leaves added to an extract liquid or a slurry can not be specified, because the activity of the raw tea leaves varies depending on the time at which the raw tea leaves are picked and on the form thereof. However, the amount is, for example, in the range of 0.001 to 20% (w/w) based on the weight of the slurry or the extract liquid to be reacted. The reaction temperature may be in the range of 0° C. to 60° C., preferably 10° C. to 50° C., and more preferably 20° C. to 40° C. The reaction time may be 10 minutes to 48 hours, and preferably 30 minutes to 24 hours. Within the above-described ranges, the flavor of the tea extract can be improved.

In the present invention, the polygalacturonase activity refers to an activity to hydrolyze α-1,4-glycosidic bonds of polygalacturonic acid. As the enzyme preparation having a polygalacturonase activity, a product commercially-available for use in foods can be used as appropriate. Since a commercially-available enzyme preparation marketed as pectinase contains polygalacturonase in many cases, it is preferably used as the enzyme preparation. Examples of the commercially-available enzyme preparation marketed as pectinase include: Pectinase G “Amano”, Pectinase PL “Amano”, Newlase F (the above are manufactured by Amano Enzyme Inc.); Pectinase 3S, Pectinase SS, Pectinase HL (the above are manufactured by YAKULT PHARMACEUTICAL INDUSTRY CO., LTD.); Sucrase N, Sucrase S (the above are manufactured by Mitsubishi-Kagaku Foods Corporation); Pectinex Ultra SP-L (manufactured by Novozymes); Meicelase (manufactured by MEIJI SEIKA KAISHA, LTD.); Ultrazym (manufactured by Novozymes); Sumizyme MC (manufactured by Shin-Nihon Chemical Co., Ltd.); and the like. Some enzyme preparations other than enzyme preparations marketed as pectinase have a polygalacturonase activity, and these may also be used. Examples of such enzyme preparations include: Cellulosin GM5, Cellulosin AC 40 (the above are manufactured by HBI Enzymes Inc.); Hemicellulase “Amano” 90, Cellulase A “Amano” 3 (the above are manufactured by Amano Enzyme Inc.); and the like.

It should be noted, however, that an enzyme preparation having a polygalacturonase activity of 30 PGU/g or more is particularly preferable because the lower the polygalacturonase activity in the enzyme preparation is, the greater the amount of the enzyme preparation that needs to be added, which increases the cost.

The polygalacturonase activity as defined herein can be determined in accordance with the following method. Note that polygalacturonic acid used was manufactured by Fluka, and acetic acid, boric acid, and 2-Cyanoacetamide used were manufactured by NACALAI TESQUE, INC.

To 200 μL of a 2% polygalacturonic acid aqueous solution, 1.6 mL of a 200 mM acetic acid buffer liquid (pH 5.0) is added, and preheated at 35° C. for 10 minutes. To this mixture, 200 μL of a 0.2 mg/mL enzyme aqueous solution is added, and the mixture is further heated at 35° C. for 30 minutes. To this mixture, 10 mL of a 100 mM boric acid buffer liquid (pH 9.0) is added, to terminate the reaction. To this mixture, 1.3 mL of a 1% 2-cyanoacetamide aqueous solution is added. This mixture is heated at 100° C. for 10 minutes, and then ice-cooled. The absorption of the liquid at 276 nm is determined by using an absorption spectrometer. As the blank, one obtained by using sterile water instead of the enzyme aqueous solution, and one obtained by using sterile water instead of the polygalacturonic acid aqueous solution were prepared.

One PGU of an enzyme activity unit is defined as an amount with which reducing sugar is produced in an amount equivalent to 1 μmol of D-galacturonic acid in 1 minute by the above-described method.

The timing of adding the enzyme preparation having a polygalacturonase activity may be the treatment the raw material tea by using the raw tea leaves or after the treatment. When the enzyme preparation is added after the treatment with the raw tea leaves, the slurry or the extract liquid is heated at 60° C. to 121° C. for 2 seconds to 30 minutes after the treatment with the raw tea leaves to inactivate the enzymes of the raw tea leaves, and cooled to a temperature at which the treatment with the enzyme preparation having a polygalacturonase activity is performed. Thereafter, the enzyme preparation is added. The amount of the enzyme preparation added is preferably 0.005 PGU/g or more, and more preferably 0.015 PGU/g or more, based on the weight of the slurry or the extract liquid to be reacted. The reaction temperature may be in the range of 0° C. to 60° C., preferably 10° C. to 50° C., and more preferably 20° C. to 40° C. The reaction time may be 10 minutes to 24 hours, and preferably 30 minutes to 3 hours.

When the enzyme preparation having a polygalacturonase activity is added during the treatment with the raw tea leaves, the addition amount is preferably 0.005 PGU/g or more, and more preferably 0.015 PGU/g or more. The conditions of the reaction are the same as the conditions for the treatment using the raw tea leaves.

After the treatment with the enzyme preparation having a polygalacturonase activity, the enzymes are inactivated by a heat treatment at 60° C. to 121° C. for 2 seconds to 30 minutes. When the reaction using the raw tea leaves is simultaneously performed with the treatment of the enzyme preparation, the raw tea leaves are also inactivated by this heat treatment.

After the inactivation, the mixture is cooled, and solid components therein can be separated by appropriate separation means such as centrifugation, or filtration using a filter paper. If desired, the obtained extract may be concentrated for use by means of vacuum distillation concentration, freeze concentration, membrane concentration, or the like. If desired, the obtained extract may be converted into a powder form by drying the obtained extract by employing appropriate drying means such as spray drying, vacuum drying, or freeze drying, with or without addition of a vehicle such as dextrin, modified starch, cyclodextrin, or gum arabic. When needed, ascorbic acid serving as an antioxidant, sodium hydrogencarbonate serving as a pH adjuster, or the like may be added to the extract at a production step, or after production.

The thus obtained tea extract does not undergo deposition formation, even when stored for a long period, and also the tea extract has an extremely excellent flavor.

The tea extract obtained by the method of the present invention can be used for, for example, beverages, particularly tea beverages, isotonic drinks, carbonated beverages, fruit juice drinks, dairy beverages, and alcoholic beverages; frozen desserts such as ice creams, sorbets, and ice lollies; pleasure products such as Japanese confectionaries, Western confectionaries, chewing gums, chocolates, breads, coffee; various kinds of snacks; and the like.

When the tea extract of the present invention is used for beverages, the following production method may be used, for example. Specifically, the tea extract obtained according to the present invention is diluted with ion-exchanged water or the like; alternatively, 0.01 to 10% (w/w) of the tea extract of the present invention may be blended into an extract obtained by extracting tea leaves with cool water or hot water. Thereafter, the pH is adjusted with a sodium hydrogencarbonate aqueous solution or the like, and the mixture is filled into a container. Before or after the filling, a sterilization treatment is performed. Thus, a product is obtained. Examples of the container into which the mixture is filled include conventionally-known cans, plastic bottles, paper containers, and the like. When needed, vitamin C, a flavor, or the like may be added at an adjustment stage before the filling. In general, for aluminum cans or steel cans, retort sterilization is preformed at 121° C. for 10 minutes, and for a paper container, sterilization is performed at 135° C. for 30 seconds.

### Example

The present invention will be described in details below with reference to the following non-limiting Examples and Comparative Examples.

### <Green Tea Extract A>

Into a column, 7.4 kg of green tea leaves produced in Shizuoka prefecture by a steaming method was charged. Ion-exchanged water at 70° C. was introduced to the column from the bottom thereof. The extract liquid was collected from the top of the column. Thus, 46 kg of an extract liquid having a Brix of 5.7% was obtained. This extract liquid was filtered through a filter paper (manufactured by Advantec Toyo Kaisha, Ltd., No. 2), and then sterilized by being heated at 95° C. for 30 seconds. The sterilized extract liquid was concentrated with an RO membrane concentration system (manufactured by NITTO DENKO CORPORATION), and then sterilized by being heated at 95° C. for 30 seconds. Thus, a green tea extract A having a Brix of 10% was obtained. This green tea extract A was used as Comparative Example 1.

(Cases where Enzyme Preparations were Added after Reaction Using Raw Tea Leaves)

In each example or comparative example, to 100 g of the green tea extract A, 0.3% (w/w) of a raw tea leaf powder (obtained by lyophilizing and then grinding raw tea leaves of first picked tea produced in Shizuoka) were added, and reaction was performed at 30° C. for 6 hours with stirring. After the reaction, the mixture was heated at 80° C. for 10 minutes to inactivate enzymes, and then cooled to 30° C.

Next, an enzyme preparation was added thereto in an amount of 0.003% (w/w) to 0.05% (w/w) relative to the amount of the liquid. Here, one of six kinds of enzyme preparations, namely, Pectinase G “Amano” (manufactured by Amano Enzyme Inc.) (polygalacturonase activity: 777 PGU/g), Cellulosin AC 40 (manufactured by HBI Enzymes Inc.) (151 PGU/g), Pectinase 3S (manufactured by YAKULT PHARMACEUTICAL INDUSTRY CO., LTD.) (62 PGU/g), Cellulosin HC (manufactured by HBI Enzymes Inc.) (26 PGU/g), Biozyme A (manufactured by manufactured by Amano Enzyme Inc.) (0 PGU/g), and Protease N “Amano” G (0 PGU/g) (manufactured by Amano Enzyme Inc.) was used. Reaction was performed at 30° C. for 1 hour. Thereafter, enzymes were inactivated by heating at 80° C. for 10 minutes. After cooling to 25° C., centrifugation was performed at 3,000 rpm for 10 minutes by using a centrifuge (KN-70 manufactured by KUBOTA CORPORATION). After the centrifugation, the supernatant was collected and then heated again at 80° C. for 10 minutes for sterilization.

An extract obtained under the same conditions except that no enzyme preparation was added to the green tea extract A was used as Comparative Example 2.

(A Case where Enzyme Preparation was Added During Reaction Using Raw Tea Leaves)

To 100 g of the green tea extract A, 0.3% (w/w) of a raw tea leaf powder and 0.05% (w/w) of Pectinase G (manufactured by Amano Enzyme Inc.) were added. Reaction was performed at 30° C. for 6 hours with stirring. After the reaction, enzymes were inactivated at 80° C. for 10 minutes. Subsequently, centrifugation was performed at 3,000 rpm for 10 minutes by using a centrifuge (KN-70 manufactured by KUBOTA CORPORATION). After the centrifugation, the supernatant was collected, and sterilized again at 80° C. for 10 minutes.

### <Comparison of Deposition Amount>

The extracts obtained in Examples 1 to 10, and Comparative Examples 1 to 4 were stored at 4° C. for 2 weeks. Thereafter, each of the extracts was stirred thoroughly, and 10 mL thereof was taken into a centrifuge tube. Then centrifugation is performed at 3,000 rpm for 10 minutes. Comparison was made of deposition amounts in the extracts.

### <Sensory Evaluation>

Each of the extracts obtained in Examples 1 to 10 and Comparative Examples 1 to 4 was diluted with ion-exchanged water to have a Brix of 0.2%, and rated by five well-trained panelists in terms of odor strength on a five-point scale, with the green tea extract A rated as being 3. The odor strength was represented by their respective average points. Note that the criteria are as follows:
5 very strong,
4 strong,
3 medium,
2 weak, and
1 very weak.

### <Quality Evaluation>

Evaluation was made in the order of ⊚>◯>Δ>X in accordance with overall judgment based on the results of the deposition amount and the sensory evaluation.
⊚ Excellent
◯ Good
Δ Acceptable
X Unacceptable

TABLE 1

| | Comparative | Comparative | Example | Example | Example | Example | Example | Example |
|---|---|---|---|---|---|---|---|---|
| | Example 1 | Example 2 | 1 | 2 | 3 | 4 | 5 | 6 |
| Amount of raw tea leave | — | 0.3 | 0.3 | 0.3 | 0.3 | 0.3 | 0.3 | 0.3 |
| powder used | | | | | | | | |
| (% (w/w)) | | | | | | | | |
| Enzyme product name used | — | — | Pectinase G | | | Cellulosin AC 40 | | |
| Polygalacturonase activity | — | — | 777 | | | 151 | | |
| (PGU/g) | | | | | | | | |
| Timing of enzyme addition | — | — | After | | | After | | |
| During or after reaction | | | | | | | | |
| using raw leaves | | | | | | | | |
| Amount of enzyme added | — | — | 0.050 | 0.010 | 0.003 | 0.050 | 0.010 | 0.003 |
| (% (w/w)) | | | | | | | | |
| Amount of enzyme added | — | — | 0.389 | 0.078 | 0.023 | 0.076 | 0.015 | 0.005 |
| (PGU/g) | | | | | | | | |
| Centrifuged amount | 0 | 18 | 0 | 0 | 0 | 0 | 0.1 | 10 |
| (% (v/v)) | | | | | | | | |
| Strength of odor | 3.0 | 4.0 | 4.8 | 4.5 | 4.3 | 4.5 | 4.3 | 4.0 |
| Quality | X | X | ⊚ | ⊚ | ⊚ | ⊚ | ⊚ | ◯ |

TABLE 2

| | Example | Example | Example | Comparative | Comparative | Example |
|---|---|---|---|---|---|---|
| | 7 | 8 | 9 | Example 3 | Example 4 | 10 |
| Amount of raw tea leave | 0.3 | 0.3 | 0.3 | 0.3 | 0.3 | 0.3 |
| powder used | | | | | | |
| (% (w/w)) | | | | | | |
| Enzyme product name used | Pectinase 3S | | Cellulosin | Biozyme A | protease N “Amano” | Pectinase |
| | | | HC | | G | G |
| Polygalacturonase activity | 62 | | 26 | 0 | 0 | 777 |
| (PGU/g) | | | | | | |
| Timing of enzyme addition | After | | After | After | After | At |
| During or after reaction | | | | | | |
| using raw leaves | | | | | | |
| Amount of enzyme added | 0.050 | 0.010 | 0.050 | 0.050 | 0.050 | 0.050 |
| (% (w/w)) | | | | | | |
| Amount of enzyme added | 0.031 | 0.006 | 0.013 | 0.000 | 0.000 | 0.389 |
| (PGU/g) | | | | | | |
| Centrifuged amount | 0 | 7 | 10 | 18 | 18 | 0 |
| (% (v/v)) | | | | | | |
| Strength of odor | 4.5 | 4.2 | 4.0 | 4.0 | 3.8 | 5.0 |
| Quality | ⊚ | ◯ | ◯ | X | X | ⊚ |

As is apparent from the results, by adding an enzyme preparation having a polygalacturonase activity, the amount of deposits formed during the storage was decreased, and the odor was made stronger than that in Comparative Example 2 where the reaction was performed by using only raw tea leaves. No deposits were formed in Comparative Example 1, whereas a large amount of deposits were present in Comparative Example 2, indicating that the deposits were formed only by the reaction between a tea extract liquid and raw tea leaves. The results of Comparative Examples 3 and 4 showed that addition of enzyme preparations without a polygalacturonase activity did not prevent the formation of the deposits, and did not provide an effect on odor exceeding the change achieved by the addition of raw tea leaves. Moreover, the results of Example 10 showed that, even when an enzyme preparation with a polygalacturonase activity was added during the reaction using the raw tea leaves, the same deposition inhibition effect as that in Example 1 was obtained, and the odor was strengthened.

### Example 11

The product of the present invention obtained in Example 1 was diluted with ion-exchanged water to have a Brix of 0.2%. Subsequently, 0.03% (w/w) of vitamin C relative to the amount of the liquid was added. The pH was adjusted to 6.0, by using sodium hydrogencarbonate. Then, the mixture was warmed to 80° C., and filled into a steel can (TOYO SEIKAN KAISHA, ltd.). After N2 gas was filled in said can, the can was sealed. Then, retort sterilization was performed at 121° C. for 10 minutes. Thus, a green tea beverage was produced.

1. A method for producing a tea extract, comprising the step of treating a raw material tea by using raw tea leaves and an enzyme preparation having a polygalacturonase activity.

2. The production method according to claim 1, wherein the raw tea leaves are raw leaves of Camellia sinensis or a non-heated processed product obtained therefrom.

3. The production method according to claim 1, wherein the enzyme preparation having a polygalacturonase activity is used in a treatment amount which has 0.005 PGU/g of the polygalacturonase activity.

4. A tea extract obtained by the production method according to claim 1.

5. A food or beverage comprising the tea extract according to claim 4.
